(19) United States
(12) Patent Application Publication
(10) Pub. No.: US 2016/0288836 A1
(43) Pub. Date: Oct. 6, 2016

(54) Motor Vehicle Body with a Deformation Element and a Side Member

(71) Applicant: Bayerische Motoren Werke Aktiengesellschaft, Muenchen (DE)

(72) Inventors: Balazs FODOR, Markt Schwaben (DE); Dirk LUKASZEWICZ, Augsburg (DE); Christian BOEGLE, Muenchen (DE)

(21) Appl. No.: 15/177,920

(22) Filed: Jun. 9, 2016

Related U.S. Application Data
(63) Continuation of application No. PCT/EP2014/076637, filed on Dec. 4, 2014.

(30) Foreign Application Priority Data
Dec. 10, 2013 (DE) 10 2013 225 406.7

(51) Int. Cl. B62D 21/15; B60R 19/34; B62D 29/04

(52) U.S. Cl. CPC B62D 21/152; B62D 29/041; B60R 19/34

(57) ABSTRACT

A body for a motor vehicle includes a side member, which is made from a fiber-reinforced plastic composite, and a deformation element. The deformation element is designed such that it can absorb collision energy in a low relative speed range of the motor vehicle through fracture. The side member is designed such that it can absorb collision energy in a high relative speed range of the motor vehicle through brittle fracture. A side member start-of-fracture force level, at which the side member first starts to fracture, is greater than a side member mean fracture force level, at which the side member goes on to fracture. A deformation element start-of-fracture force level, at which the deformation element first starts to fracture, and a deformation element mean fracture force level, at which the deformation element goes on to fracture, are lower than the side member start-of-fracture force level. The deformation element mean fracture force level is lower than the side member start-of-fracture force level and greater than a force level corresponding to a side member mean fracture force level reduced by 10%, preferably 5%.

### CROSS REFERENCE TO RELATED APPLICATIONS

This application is a continuation of PCT International Application No. PCT/EP2014/076637, filed Dec. 4, 2014, which claims priority under 35 U.S.C. §119 from German Patent Application No. 10 2013 225 406.7, filed Dec. 10, 2013, the entire disclosures of which are herein expressly incorporated by reference.

### BACKGROUND AND SUMMARY OF THE INVENTION

The present invention relates to a body for a motor vehicle with a deformation element and a side member made from a fiber reinforced plastic composite material.

A conventional motor vehicle usually consists of a front part, a rear part and a passenger compartment which is arranged in between. Here, a construction of the front part takes, in particular, a frontal collision of the motor vehicle with a collision obstacle into consideration. A collision-relevant structure of the motor vehicle which can sufficiently dissipate collision energy in order to protect vehicle occupants is also called a crash structure. The collision-relevant structure of the front part is frequently defined, inter alia, by two front side members which are also called engine subframes in the case of motor vehicles with an engine at the front, deformation elements which are arranged at front ends of the side members and are also called “crash boxes”, and a bumper with a bumper crossmember. Here, the deformation elements are as a rule designed for a collision event at low speed, which deformation elements are intended to protect the further structure of the front part, in particular the front side members against damage. Therefore, in the case of a collision at low speed, usually only the bumper with the bumper crossmember and the deformation elements are damaged in an energy-absorbing manner and can be replaced easily again for repair purposes. In the case of a collision at high speed, the remaining structure of the front part, in particular the front side members, also have to dissipate collision energy. The front side members are usually configured in a shell design made from steel. The crash boxes are frequently configured from aluminum. Here, the failure of the front side members is characterized by plastic deformation, a force level dropping during the course of the deformation, that is to say as the deformation increases. The force level, at which the crash boxes fail, is usually selected here to be at least 20% lower than the force level, at which the plastic failure of the front side member made from steel starts. As a result, the force level, at which the crash boxes fail, is comparatively low, with the result that a comparatively long deformation path of the crash boxes is required, in order to sufficiently dissipate the collision energy in the case of a collision at low speed.

It is known to design a body structure support for a body of a motor vehicle in such a way that, in the case of a collision of the motor vehicle, it fails in a manner which absorbs collision energy. Here, body structure supports made from metallic materials are designed in such a way that, if a predefined force level is exceeded, they deform in a suitable manner over a distance which is provided for this purpose. In the case of body structure supports made from fiber reinforced plastic, however, a dissipation of collision energy by way of deformation does not play any role. A sufficient dissipation of collision energy in the case of a body structure support made from fiber reinforced plastic is a brittle failure. A failure of this type is called, for example, “crushing”. In the case of the “crushing” failure mechanism, a disintegration which is more or less complete (called pulverization or fragmentation or else splintering) of the body structure support takes place predominantly in a brittle fracture. A further form of “crushing” is a defined deflection of the material by 180° directly at an impact surface, said deflection also being called peeling open or peeling. In the case of crushing, a fiber rupture mechanism in conjunction with friction acts to dissipate the kinetic collision energy. The two abovementioned failure mechanisms function effectively in the case of a frontal impact, in which the force on the body structure support lies perpendicularly with respect to a support cross section. Between the abovementioned failure types of “crushing”, there are all possible intermediate forms of failure which differ fundamentally as a result of a fiber rupture into greater or smaller parts. The smaller the parts in the failure, the higher the collision energy absorption capability during failure and/or the higher the load/force, at which the failure takes place.

It is the object of the present invention to provide a body for a motor vehicle with a deformation element and a side member, the crash structure of which has a short deformation path with sufficient dissipation of collision energy.

This and other objects are achieved by a body according to the invention for a motor vehicle having a side member, which is configured from a fiber reinforced plastic composite material, and a deformation element. A deformation element of this type is also called a crash box or impact energy absorption element. The deformation element is configured in such a way that it can absorb collision energy in a low relative speed range of the motor vehicle by way of failure. Here, relative speed means a speed of the motor vehicle with respect to a collision opponent. In the case of a rigid, stationary collision opponent, the relative speed corresponds to the speed of the motor vehicle. The side member is configured in such a way that it can absorb collision energy in a high relative speed range of the motor vehicle by way of brittle failure. Here, the side member can preferably absorb collision energy at a substantially constant force level. Here, the high relative speed range preferably adjoins the low relative speed range. A side member initial failure force level, at which the side member first begins to fail, after initial elastic deformation, is greater than a side member mean failure force level, at which the side member fails in a further process. Furthermore, a deformation element initial failure force level, at which the deformation element first begins to fail, and a deformation element mean failure force level, at which the deformation element fails in a further process, are lower than the side member initial failure force level. Moreover, the deformation element mean failure force level is lower than the side member initial failure force level and greater than a force level which corresponds to a side member mean failure force level which is reduced by 10%, preferably 5%.

An abovementioned brittle failure of the side member made from fiber reinforced plastic composite material is also called “crushing”, for example. In the case of the “crushing” failure mechanism, more or less complete disintegration (called pulverization or fragmentation or else splintering) of the fiber reinforced plastic composite material takes place predominantly in a brittle fracture. The smaller the parts in the failure, the higher the collision energy absorption capability during failure and/or the higher the load/force, at which the failure takes place.

The use of a fiber reinforced plastic composite material for the side member makes it possible to realize a comparatively constant failure force level, in particular in comparison with metallic materials, after the initial failure force level. Since, according to the invention, the deformation element mean failure force level is selected to be comparatively high, namely at least greater than a side member mean failure force level which is reduced by 10%, preferably 5%, the dissipation of collision energy by way of the deformation element takes place at a comparatively high force level, as a result of which a required deformation path is shorter. This in turn has the advantage that the crash structure, for example of a front part of the motor vehicle, can be of considerably shorter configuration. The motor vehicle can be of smaller configuration overall and/or a passenger compartment can be of larger configuration with an identical overall size of the motor vehicle. The invention is made possible, in particular, by virtue of the fact that the side member is configured from fiber reinforced plastic composite material, the initial failure force level of which can be adjusted to be comparatively great, with the result that a probability that the side member begins to fail before a collision energy dissipation potential of the deformation element is exploited is very low despite a deformation element mean failure force level which lies close to the side member mean failure force level. It can therefore be ensured with high probability that, in the case of a collision at a low speed, the side member is not damaged irreversibly and first of all the deformation element fails completely.

According to one preferred development of the invention, the deformation element mean failure force level is greater than or equal to the side member mean failure force level. As a result, it is possible to select an even shorter deformation path of the deformation element with an identical collision energy dissipation potential.

According to a further preferred development of the invention, the deformation element mean failure force level is lower than a side member mean failure force level which is increased by 10%. This ensures that the deformation element mean failure force level does not approximate too closely to the side member initial failure force level and a failure of the side member does not begin unintentionally.

The deformation element can be configured in such a way that it fails in a plastic and/or brittle manner.

The deformation element can preferably consist of a fiber reinforced plastic composite material.

As a result, the deformation element can possibly be of lighter configuration. Furthermore, a failure force level of the deformation element can be of comparatively constant configuration, with the result that a deformation path of the deformation element can be utilized particularly efficiently to absorb collision energy.

The deformation element is advantageously arranged between a bumper crossmember and a front end of the side member.

According to one development, the deformation element can be configured such that it can be replaced by way of releasable fasteners.

As a result, in particular in the case of the collision at low speed, it is possible to simply replace the damaged deformation element inexpensively.

The side member can advantageously be a front side member or a rear side member. A front bumper crossmember with a deformation element which is arranged in between can be arranged on the front side member. A rear bumper crossmember with a deformation element which is arranged in between can be arranged on the rear side member. The front side member and/or rear side member and associated deformation elements can be arranged in pairs. In other words, the body can have a left-hand and a right-hand front side member and/or a left-hand and a right-hand rear side member with associated deformation elements.

The side member can preferably consist of a fiber reinforced plastic composite material with carbon fibers.

This is advantageous in so far as carbon fibers have a high tensile strength with a comparatively low weight. It is therefore possible to configure a crash structure to be particularly short with identical occupant safety.

The fiber reinforced plastic composite material is advantageously configured with continuous fibers. Continuous fibers make a particularly high strength of the side member and therefore also a higher failure force level possible, which additionally makes a particularly short crash structure possible.

The side member preferably fails at a substantially constant force level.

The above-described developments of the invention can be combined as desired with one another if possible and appropriate.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of a force profile over a deformation path of a deformation element and a side member according to a first exemplary embodiment of the present invention.

FIG. 2 is a schematic diagram of a force profile over a deformation path of a deformation element and a side member according to a second exemplary embodiment of the present invention.

### DETAILED DESCRIPTION OF THE DRAWINGS

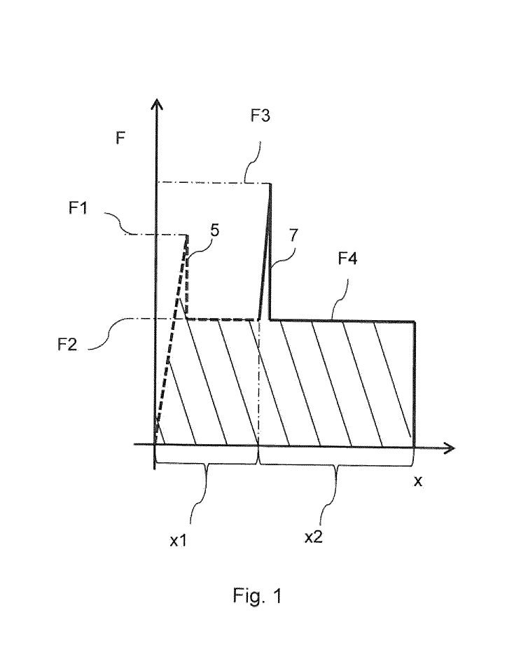

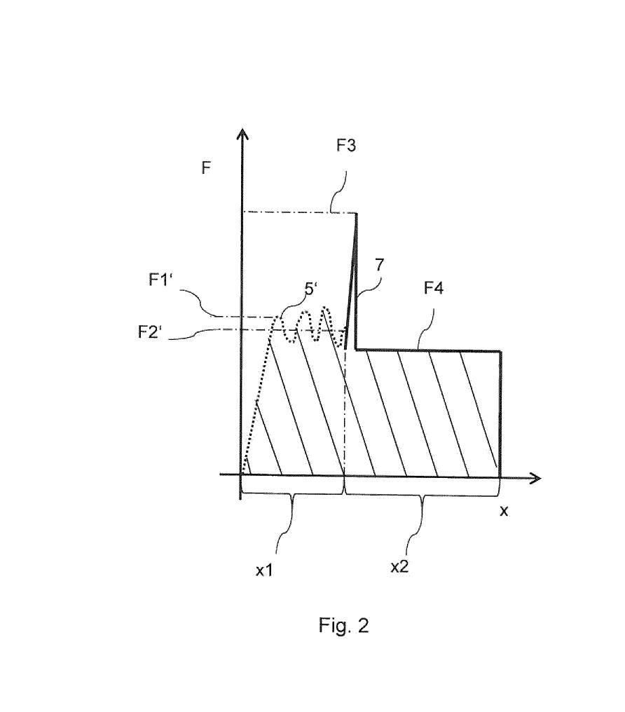

In the following text, a first exemplary embodiment and a second exemplary embodiment of the present invention are explained with reference to FIGS. 1 and 2.

According to the first exemplary embodiment, a body for a motor vehicle has a front side member which is configured from fiber reinforced plastic composite material and a deformation element. The front side member is reinforced, in particular, with continuous fibers made from carbon. The deformation element is attached between a front bumper crossmember and a front end of the side member. The deformation element of the first exemplary embodiment is configured from fiber reinforced plastic composite material which fails in a brittle manner.

The deformation element is designed in such a way that it can absorb collision energy in the case of a collision at a low speed, that is to say, for example, lower than 25 km/h, 20 km/h or 15 km/h or any desired value which lies in between, in particular 16 km/h, without the side member which is arranged behind it being damaged irreversibly.

FIG. 1 shows a schematic diagram of a force profile in the case of a frontal collision of the motor vehicle at a high relative speed with a collision obstacle over a deformation path of the deformation element and the side member. After initial elastic deformation, the deformation element fails in a brittle manner by way of what is known as crushing when a deformation element initial failure force level F1 is reached, the deformation element failing when the deformation element initial failure force level F1 is exceeded at an approximately continuously constant deformation element mean failure force level F2 which is lower than the deformation element initial failure force level F1. A failure force profile 5 of the deformation element is shown schematically by way of a dashed line in FIG. 1, the line being shown in an idealized manner. The failure force profile can actually also fluctuate somewhat, the failure force profile being subject to considerably lower fluctuations than in the case of a plastically deformable deformation element which is described in the second exemplary embodiment. The maximum deformation path of the deformation element is indicated by x1 in the diagram.

As soon as the collision energy dissipation potential or a deformation potential of the deformation element is exhausted, a failure of the side member occurs. A failure force profile 7 of the side member is shown by way of a solid line in FIG. 1. Here, in the case of elastic deformation of the side member, the force first of all rises to a side member initial failure force level F3, at which the side member begins to fail. In particular, the side member fails in a brittle manner by way of crushing which has already been described in the above text. A further force profile, in which the side member fails, is indicated by the side member mean failure force level F4, the force profile being comparatively constant after the initial failure, in particular in comparison with a side member made from metallic material which fails in a plastic manner. The failure force profile 7 is shown in an idealized manner in FIG. 1. The side member mean failure force level F4 is lower than the side member initial failure force level F3. The maximum deformation path of the side member is indicated by x2 in the diagram.

Collision energy which can be absorbed by the system including the deformation element and side member is indicated in the diagram by way of the hatched region.

In the diagram, the deformation element initial failure force level F1 and the deformation element mean failure force level F2 are in each case configured to be lower than the side member initial failure force level F3. This prevents the side member failing before a complete failure of the deformation element. In order to ensure this in every case, a difference of the force levels F1 and F2 to the side member initial failure force level F3 is selected to be sufficiently great.

Furthermore, in the exemplary embodiment which is shown, the deformation element mean failure force level F2 is approximately equal to the side member mean failure force level F4. As a result, the force level, at which the deformation element fails, is comparatively high, with the result that sufficient collision energy can also be dissipated via the deformation element in the available deformation path x1. The deformation element mean failure force level F2 can also be configured in a range from 10% smaller than the side member mean failure force level F4 to 10% greater than the side member mean failure force level F4, as long as a side member initial failure force level F3 is great enough for a failure of the side member to not occur before a complete failure of the deformation element.

In the following text, the second exemplary embodiment of the present invention is described with reference to FIG. 2, the differences from the first exemplary embodiment being described, in particular, and a description of the common features with the first exemplary embodiment having been substantially omitted.

According to the second exemplary embodiment, a body for a motor vehicle has a front side member which is configured from fiber reinforced plastic composite material, and a deformation element which, in contrast to the first exemplary embodiment, is configured from an aluminum material.

In the case of a frontal collision, the deformation element fails in a substantially plastic manner after initial elastic deformation when a deformation element initial failure force level F1′ is reached, the deformation element failing after the deformation element initial failure force level F1′ is exceeded with a greatly fluctuating failure force profile 5′ which is characteristic for a failure of an aluminum deformation element. A mean value of the fluctuating failure force profile 5′ after the initial failure force level F1′ is reached is shown in the diagram by way of a deformation element mean failure force level F2′. The deformation element mean failure force level F2′ is lower than the deformation element initial failure force level F1′. A maximum deformation path of the deformation element is indicated in the diagram by x1.

As soon as the collision energy dissipation potential or a deformation potential of the deformation element is exhausted, a failure of the side member occurs. A failure force profile 7 of the side member according to the second exemplary embodiment corresponds to the failure force profile of the side member according to the first exemplary embodiment and is shown in FIG. 2 by way of a solid line in an analogous manner to the first exemplary embodiment. The deformation element initial failure force level F1′ and the deformation element mean failure force level F2′ are in each case lower than a side member initial failure force level F3, the deformation element mean failure force level F2′ of the second exemplary embodiment being configured to be somewhat greater than a side member mean failure force level F4.

Overall, according to the exemplary embodiments of the present invention, a comparatively high amount of collision energy can be absorbed within the available deformation path x1+x2, the function of the deformation element to protect the side member against irreversible damage in the case of collisions at low speeds being maintained.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A body for a motor vehicle, comprising:
a side member configured from a fiber reinforced plastic composite material;
a deformation element configured to absorb collision energy in a low relative speed range of the motor vehicle by way of failure, wherein
the side member is configured to absorb collision energy in a high relative speed range of the motor vehicle by way of brittle failure,
a side member initial failure force level, at which the side member first begins to fail, is greater than a side member mean failure force level, at which the side member fails in a further process, and
a deformation element initial failure force level, at which the deformation element first begins to fail, and a deformation element mean failure force level, at which the deformation element fails in a further process, are lower than the side member initial failure force level, and
the deformation element mean failure force level is lower than the side member initial failure force level and greater than a force level corresponding to the side member mean failure force level reduced by approximately 10%.

2. The body for the motor vehicle according to claim 1, wherein the deformation element mean failure force level is lower than the side member initial failure force level and greater than the force level corresponding to the side member mean failure force level reduced by approximately 5%.

3. The body for the motor vehicle according to claim 1, wherein the deformation element mean failure force level is greater than or equal to the side member mean failure force level.

4. The body for the motor vehicle according to claim 1, wherein the deformation element mean failure force level is lower than a side member mean failure force level which is increased by 10%.

5. The body for the motor vehicle according to claim 3, wherein the deformation element mean failure force level is lower than a side member mean failure force level which is increased by 10%.

6. The body for the motor vehicle according to claim 1, wherein the deformation element is configured to fail in a plastic and/or brittle manner.

7. The body for the motor vehicle according to claim 1, wherein the deformation element is made of a fiber reinforced plastic composite material.

8. The body for the motor vehicle according to claim 1, further comprising:
a bumper crossmember, wherein
the deformation element is arranged between the bumper crossmember and a front end of the side member.

9. The body for the motor vehicle according to claim 1, wherein the deformation element is configured to be replaceable via releasable fasteners.

10. The body for the motor vehicle according to claim 1, wherein the side member is a front side member or a rear side member.

11. The body for the motor vehicle according to claim 1, wherein the side member is made of a fiber reinforced plastic composite material with carbon fibers.

12. The body for the motor vehicle according to claim 1, wherein the fiber reinforced plastic composite material is configured with continuous fibers.
